(19) United States
(12) Patent Application Publication
(10) Pub. No.: US 2018/0350038 A1
(43) Pub. Date: Dec. 6, 2018

(54) Methods and Systems for Light Field Compression With Residuals

(71) Applicant: Ostendo Technologies, Inc., Carlsbad, CA (US)

(72) Inventors: Song Cen, San Diego, CA (US); Zahir Y. Alpaslan, San Marcos, CA (US); Hussein S. El-Ghoroury, Carlsbad, CA (US)

(21) Appl. No.: 15/994,328

(22) Filed: May 31, 2018

Related U.S. Application Data
(60) Provisional application No. 62/514,521, filed on Jun. 2, 2017.

(51) Int. Cl. G06T 3/40; G06T 7/557; G06T 5/50

(52) U.S. Cl. CPC G06T 3/40; G06T 7/557; G06T 2207/20224; G06T 2207/10052; G06T 5/50

(57) ABSTRACT

Methods and systems for light field compression are disclosed. According to some embodiments, the method receives pre-processing information that includes subimages associated with a scene. The method performs a first compression operation on the pre-processing information to generate reference information. The method further performs a second compression operation on the reference information and residual information to output compressed information. The compressed information includes compressed reference information and compressed residual information.

### CROSS REFERENCE TO RELATED APPLICATIONS

This application claims the benefit of U.S. Provisional Application No. 62/514,521 filed on Jun. 2, 2017, the disclosure of which is incorporated by reference herein.

### FIELD OF THE INVENTION

Embodiments of the invention relate to image and video compression. More specifically, embodiments of the invention relate to the compression of light field image data as input for light field imaging systems.

### BACKGROUND

### References Cited

U.S. Publication No. US 2009/0086170 A1, “Quantum Photonic Imagers and Methods of Fabrication Thereof”, Apr. 2, 2009.
U.S. Publication No. US 2010/0225679 A1, “Multi-Pixel Addressing Method for Video Display Drivers”, Sep. 9, 2010.
U.S. Pat. No. 8,401,316 B2, “Method and Apparatus for Block-based Compression of Light Field Images”, Mar. 19, 2013.
U.S. Publication No. US 2013/0077880, “Systems and Methods for Encoding Light Field Image Files”, Mar. 28, 2013.
U.S. Publication No. US 2013/0077882, “Systems and Methods for Decoding Light field Image Files”, Mar. 28, 2013.
U.S. Publication No. US 2011/0134227 A1, “Methods and Apparatuses for Encoding, Decoding, and Displaying a Stereoscopic 3D Image”, Jun. 9, 2011.
U.S. Pat. No. 5,613,048, “Three-dimensional Image Synthesis Using View Interpolation”, Mar. 18, 1997.
U.S. Publication No. US 2008/0043095, “Method and System for Acquiring, Encoding, Decoding and Displaying 3D Light Fields”, Feb. 21, 2008.
U.S. Pat. No. 6,009,188, “Method and System for Digital Plenoptic Imaging”, Dec. 28, 1999.
U.S. Pat. No. 6,738,533 B1, “Minimum Sampling Rate and Minimum Sampling Curve for Image-based Rendering”, May 18, 2004.
U.S. Pat. No. 8,284,237 B2, “Rendering Multiview Content in a 3D Video System”, Oct. 9, 2012.
U.S. Publication No. US 2012/0213270 A1, “Method and Apparatus for Compressive Imaging Device”, Aug. 23, 2012.
U.S. Pat. No. 6,097,394, “Method and System for Light Field Rendering”, Apr. 28, 1997.
U.S. Publication No. US 2013/0010057, “3D Disparity Maps”, Jan. 10, 2013.
U.S. Publication No. US 2010/0156894, “Rendering 3D Data to Hogel Data”, Jun. 24, 2010.
U.S. Publication No. US 2010/0231585, “Systems and Methods for Processing Graphics Primitives”, Sep. 16, 2010.
U.S. Pat. No. 6,963,431, “Rendering Methods for Full Parallax Autostereoscopic Displays”, Nov. 8, 2005.
A. Vetro, T. Wiegand, G. Sullivan, “Overview of the stereo and multiview video coding extensions of the H.264/MPEG-4 AVC standard”, Proceedings of the IEEE, vol. 99, no. 4, April 2011.
ISO/IEC JTC1/SC29/WG11, Call for Proposals on 3D Video Coding Technology, Geneva, Switzerland, March 2011.
Levoy and Hanrahan, “Light Field Rendering”, Computer Graphics, SIGGRAPH 96 Proceedings, pp. 31-42, 1996.
Magnor and Girod, “Data Compression for Light-Field Rendering”, IEEE Transaction on Circuits and Systems for Video Technology, v. 10, n. 3, April 2000, pp. 338-343.
Candès, E., Romberg, J., Tao, T., “Robust uncertainty principles: Exact signal reconstruction from highly incomplete frequency information”, IEEE Trans. Inform. Theory 52 (2006) 489-509.
David Donoho, “Compressed sensing,” IEEE Transactions on Information Theory, Volume 52, Issue 4, April 2006, Pages: 1289-1306.
Candès, E., Tao, T., “Near optimal signal recovery from random projections and universal encoding strategies,” (2004).
Gordon Wetzstein, G., Lanman, D., Hirsch, M., Heidrich, W., and Raskar, R., “Compressive Light Field Displays”, IEEE Computer Graphics and Applications, Volume 32, Issue 5, Pages: 6-11, 2012.
Heide, F., Wetzstein, G., Raskar, R. and Heidrich, W., “Adaptive Image Synthesis for Compressive Displays”, Proc. of SIGGRAPH 2013 (ACM Transactions on Graphics 32, 4), 2013.
Hoffman, D., Girshick, A., Akeley, K. & Banks, M. (2008), “Vergence-accommodation conflicts hinder visual performance and cause visual fatigue”, Journal of Vision 8 (3), 33.
ISO/IEC 14496-10:2003, “Coding of Audiovisual Objects—Part 10: Advanced Video Coding,” 2003, also ITU-T Recommendation H.264 “Advanced video coding for generic audiovisual services”.
C. Fehn, “3D-TV Using Depth-Image-Based Rendering (DIBR),” in Proceedings of Picture Coding Symposium, San Francisco, Calif., USA, December 2004.
Malvar, H. S., Sullivan, G. J., and Srinivasan, S., “Lifting-Based Reversible Color Transformations for Image Compression”, Proceeding SPIE Applications of Digital Image Processing, 2008.
M. Lucente, “Diffraction-Specific Fringe Computation for Electro-Holography”, Doctoral Thesis Dissertation, MIT Depart. of Electrical Engineering and Computer Science, September 1994.
Z. Alpaslan et al, U.S. Publication No. US2013/0141895, Spatio-Optical Directional Light Modulator, Dec. 16, 2011.
H. S. El-Ghoroury et al, U.S. Publication No. US2013/0258451, Spatio-temporal Directional Light Modulator, Jul. 11, 2012.
S. Guncer, U.S. Publication No. US2010/0007804, Image Construction Method Based Video Display System, Jan. 14, 2010.
S. Guncer, U.S. Publication No. US2010/0225679, Multi-Pixel Addressing Method for Video Display System, Sep. 9, 2010.
H. S. El-Ghoroury et al, U.S. Publication No. US2013/0321581, Spatio-Temporal Light Field Cameras, Oct. 24, 2012.

Depth perception in the human visual system (HVS) relies on several depth cues. These cues can be categorized as either psychological (e.g., perspective, shading, lighting, relative size, occlusion and texture gradient, etc.) or physiological depth cues (e.g., vergence, accommodation, motion parallax, binocular disparity, etc.). While psychological depth cues provide a relative understanding of the depth in a light field, physiological depth cues provide absolute depth information. Commercially available three-dimensional (3D) displays often use a subset of the physiological depth cues to enhance the light field viewing experience.

Glasses-based 3D displays have been gaining popularity since the introduction of glasses-based 3D televisions (TVs) sold by all major TV manufacturers. A shortcoming of the currently available technology is paradoxically the actual use of 3D glasses, which glasses can be categorized as either active or passive. In general, glasses-based technology is known to be uncomfortable for viewers to use for long time periods and poses challenges for people who require prescription glasses.

Existing autostereoscopic displays use directional modulators (such as parallax barriers or lenticular sheets) attached to a display surface to create a 3D effect without requiring glasses. Commercially available autostereoscopic displays typically use horizontal parallax to present 3D information to the viewer. Deficiencies of this form of display technology include a limited viewing angle and a limited resolution per view, each of which results in a lower quality 3D image. In addition, within the viewing angle of such displays, the user is required to keep his or her head vertical. Otherwise, the 3D effect would disappear.

Long viewing times in both glasses-based 3D displays and in horizontal parallax-only light field displays typically cause discomfort due to a physiological effect known as “vergence accommodation conflict” (VAC). See, e.g., Hoffman, D., Girshick, A., Akeley, K. & Banks, M. (2008), “Vergence-accommodation conflicts hinder visual performance and cause visual fatigue”, Journal of Vision 8 (3), 33. VAC is caused by the fact the viewer's eyes are focused on the display surface plane but also need to converge away from it in order to perceive objects that are depicted at different depths, and thus viewer discomfort occurs.

A more natural 3D effect is achieved using full parallax 3D display technology. In addition to horizontal parallax, full parallax 3D display technology includes vertical parallax such that a vertical movement of the viewer provides a different view of the 3D scene. Full parallax displays generally have an order of magnitude or more views than horizontal parallax-only displays. Arranging these views densely creates a very natural 3D image that does not change when a user moves or tilts his or her head, and also eliminates VAC by providing correct accommodation and vergence cues. 3D displays that eliminate the VAC may be referred to as “VAC-free” 3D displays.

The main challenge associated with the aforementioned full parallax 3D displays is that the increase in modulated image resolution required to render full parallax 3D images with wide viewing angles creates a new impairment for the display system, namely, a dramatically increased amount of image data. The generation, acquisition, transmission and modulation (or display) of very large image data sets required for a VAC-free full parallax light field display requires a data rate in the tens of terabits per second (Tbps).

A brief inspection of light field input images shows the ample inherent correlation between the light field data elements (known as holographic elements or “hogels”) and compression algorithms that have been proposed to deal with this type of data in the prior art. See, e.g., M. Lucente, “Diffraction-Specific Fringe Computation for Electro-Holography”, Doctoral Thesis Dissertation, MIT Depart. of Electrical Engineering and Computer Science, September 1994. However, as can be appreciated by those skilled in the art, only a limited number of the compression methods described in the prior art can practically be implemented in real-time and none of these methods can render and/or compress the amount of data required to drive a full parallax VAC-free display in real-time.

For example, currently, the most advanced video compression format, H.264/AVC, can compress ultra-high resolution video frames (4,096×2,304 @ 56.3, or 0.5 Gpixels/sec.) at a data bit rate of approximately 3 Gbits/sec. See, e.g., ISO/IEC 14496-10:2003, “Coding of Audiovisual Objects—Part 10: Advanced Video Coding,” 2003, also ITU-T Recommendation H.264 “Advanced video coding for generic audiovisual services”. H264/AVC fails to achieve sufficient compression needed for the useable transmission of light field image data, much less if the light field is refreshed in real time at a 60 Hz video rate where data rates can reach up to 86 Tbps.

Current compression standards do not exploit the high correlation that exists both in horizontal and vertical directions in a full parallax light field image. New compression standards targeting 3D displays are being developed. Nevertheless, they are targeting horizontal parallax only, a limited number of views, and usually require an increased amount of memory and related computational resources. Compression algorithms must balance image quality, compression ratio and computational load. As a general rule, a higher compression ratio in an encoder increases the computational load, making real-time implementation difficult. If both high compression and decreased computational load is required, then image quality is sacrificed. A compression solution that is able to simultaneously provide high image quality, a high compression ratio and relatively low computational load is highly desired.

### BRIEF DESCRIPTION OF THE DRAWINGS

Embodiments of the invention are illustrated by way of example and not limitation in the figures of the accompanying drawings in which like references indicate similar elements.

FIG. 1 illustrates a light field imaging system according to one embodiment of the invention.

FIG. 2 is a flow diagram illustrating a method of light field compression according to one embodiment of the invention.

FIG. 3 is a flow diagram illustrating a method of light field decompression according to one embodiment of the invention.

FIG. 4 is a flow diagram illustrating a method of adjusting levels of compression according to one embodiment of the invention.

FIG. 5 is a block diagram illustrating an example of light field compression architecture according to one embodiment of the invention.

FIG. 6 is a block diagram illustrating another example of light field compression architecture according to one embodiment of the invention.

FIG. 7 is a block diagram of a data processing system, which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment”, “an embodiment” or “some embodiments” means that a particular feature, structure, or characteristic described in conjunction with the embodiment can be included in at least one embodiment of the invention. The appearances of the phrase “in one embodiment” in various places in the specification do not necessarily all refer to the same embodiment. Random access refers to access (read/write) to a random offset of a file at least once during a read/write input/output operation.

Aspects of the invention herein introduce light field compression methods that overcome the drawbacks of the prior art, thereby making it feasible to create VAC-free full parallax 3D displays that utilize the compression methods of this invention for compressed light field imaging systems to reduce the required data rate, the processing requirements in both encoding and decoding and also power consumption for the entire imaging system. Additional advantages of the invention will become apparent from the following detailed description of various embodiments thereof that proceeds with reference to the accompanying drawings.

As is known, the transmission of large data sets can be facilitated with the use of a compressed data format. In conventional light field systems, the entire light field is first captured, and then it is compressed (or encoded) using either conventional image/video compression algorithms or light-field specific encoders. The compressed data can then be transmitted, stored and/or reconditioned for the light field display, where it is decompressed (or decoded) and modulated (examples of prior art light field compression systems are disclosed in, for instance, U.S. Pat. No. 8,401,316 B2, and U.S. Publication No. US2013/0077880).

Light fields can be compressed using a multi-view compression (MVC) standard. See, e.g., A. Vetro, T. Wiegand, G. Sullivan, “Overview of the stereo and multiview video coding extensions of the H.264/MPEG-4 AVC standard”, Proceedings of the IEEE, vol. 99, no. 4, April 2011. Using the MVC standard, the hogels are interpreted as frames of a multi-view sequence and the disparity between images is estimated and encoded. The block-based disparity estimation generates inaccuracies that are encoded by a block-based encoder, and the compression performance grows linearly with the number of images.

To improve multi-view coding, new coding standards are considering the adoption of techniques from the field of computer vision. See, e.g., ISO/IEC JTC1/SC29/WG11, Call for Proposals on 3D Video Coding Technology, Geneva, Switzerland, March 2011. With the use of per-pixel depth information, reference images can be projected to new views and the synthesized images can be used instead of the costly transmission of new images. This technique requires increased computational resources and local memory on the decoder side, posing a challenge for its real-time implementation. Prior art compression tools are also targeting their use in horizontal-only multiview sequences and do not exploit the geometric arrangement of integral images.

Methods developed exclusively for light field image compression include a vector quantization method described by Levoy et al., “Light Field Rendering”, Computer Graphics, SIGGRAPH 96 Proceedings, pp. 31-42, 1996, and video compression-based methods described by Magnor et al., “Data Compression for Light-Field Rendering”, IEEE Transaction on Circuits and Systems for Video Technology, v. 10, n. 3, April 2000, pp. 338-343. The use of vector quantization is limited and cannot achieve high compression performances such as those presented by Magnor et al., which methods are similar to a multiview compression algorithm where the geometrical regularity of the images is exploited for disparity estimation. However, these methods require an increased amount of local memory and are not well-suited for real-time implementation.

Along with the problem of image data compression, there is a related issue of image data acquisition. The generation of the entire light field for encoding requires large amounts of processing throughput and memory, and many samples may be discarded at the compression stage. A recently developed technique referred to as “Compressed Sensing” (CS) attempts to address this problem. The underlying principal behind Compressive Sensing is that a signal that is highly compressible (or equivalently sparse) in some transform domains can be minimally sampled using an incoherent basis and still be reconstructed with acceptable quality. See, e.g., Candès, E., Romberg, J., Tao, T., “Robust uncertainty principles: Exact signal reconstruction from highly incomplete frequency information”, IEEE Trans. Inform. Theory 52 (2006) 489-509. See also, e.g., David Donoho, “Compressed sensing,” IEEE Transactions on Information Theory, Volume 52, Issue 4, April 2006, Pages: 1289-1306.

This new paradigm shifts the complexity from the acquisition to the reconstruction process, which results in the need for more complex decoders. This tendency is aligned with the trend of computational displays which present computational capability directly in the display devices. Displays that have computational capacity and are able to deal directly with compressed image data are known to those skilled in the art of image processing and light field technology as “compressive displays”. See, e.g., Gordon Wetzstein, G., Lanman, D., Hirsch, M., Heidrich, W., and Raskar, R., “Compressive Light Field Displays”, IEEE Computer Graphics and Applications, Volume 32, Issue 5, Pages: 6-11, 2012; Heide, F., Wetzstein, G., Raskar, R. and Heidrich, W., “Adaptive Image Synthesis for Compressive Displays”, Proc. of SIGGRAPH 2013 (ACM Transactions on Graphics 32, 4), 2013. See also, e.g., S. Guncer, U.S. Publication No. US2010/0007804, Image Construction Method Based Video Display System, Jan. 14, 2010; S. Guncer, U.S. Patent Publication No. US2010/0225679, Multi-Pixel Addressing Method for Video Display System, Sep. 9, 2010.

In Graziosi et al., “Depth assisted compression of full parallax light fields”, IS&T/SPIE Electronic Imaging. International Society for Optics and Photonics (Mar. 17, 2015), a synthesis method that targets light fields and uses both horizontal and vertical information was introduced. The above method adopts aspects of a method called Multiple Reference Depth-Image Based Rendering (MR-DIBR) and utilizes multiple references with associated disparities to render the light field. In this approach, disparities are first forward warped to a target position. Next, a filtering method is applied to the warped disparities to mitigate artifacts such as cracks caused by inaccurate pixel displacement. The third step is the merging of all of the filtered warped disparities. Pixels with smaller depths (i.e., those closest to the viewer) are selected. Finally, the merged elemental image disparity is used to backward warp the color from the references' colors and to generate the final synthesized elemental image.

Prior art light field compression methods using depth image-based rendering (DIBR), while efficient for compression of elemental images, are unable to incorporate occlusion and hole-filling functions necessary to provide high quality light field images at acceptable compression ratios. An example of such a prior art DIBR compression method is disclosed in, for instance, U.S. Publication No. 2016/0360177 entitled, “Methods for Full Parallax Compressed Light Field Synthesis Utilizing Depth Information”, the entire contents of which are incorporated herein by reference.

As detailed in U.S. Publication No. 2016/0021355, “Preprocessor for Full Parallax Light Field Compression”, the disclosure of which are incorporated herein by reference, MR-DIBR enables the reconstruction of other perspectives from reference images and from reference disparity maps. Reference images and reference disparity maps are initially selected via a “visibility test” in one embodiment. The visibility test makes use of: 1) the distance of the objects from the modulation surface, and 2) the display's field of view (“FOV”), to determine and define the reference images and disparity maps used by the method.

In general, a scene that contains objects that are farther from the modulation surface tends to result in a smaller number of reference images and reference disparity maps as compared to a scene that contains objects that are closer to the modulation surface. Smaller numbers of reference images and reference disparity maps result in a higher compression ratio. In general, however, higher compression ratios also mean greater degradation in the decoded image.

Accordingly, the prior art fails to adequately address the need for high compression ratio, high quality, low computational load light field data compression as is required for practical implementation of VAC-free full parallax, and wide viewing angle 3D display technologies.

Aspects of the invention improve upon a method of light field compression, for example compressed rendering and MR-DIBR. The general concept is to further compress the output of the light field compression method (e.g., reference elemental images and depth or disparity maps) as well as the residuals of synthesized elemental images using video compression methods such as High Efficiency Video Coding (HEVC).

In the prior art, reference images, reference disparity maps, and residuals are generally converted to seed images and seed disparity maps, and then further compressed before being sent to a display. In one aspect of the invention, reference images, reference disparity maps, and residuals are directly encoded without being converted to seed images and seed disparity maps. In addition, aspects of the invention include various methods for adjusting the bit rate by adjusting the amount of compression at different stages of the process.

According to one aspect of the invention, the method receives pre-processing information that includes subimages associated with a scene. The method performs a first compression operation on the pre-processing information to generate reference information. The method further performs a second compression operation on the reference information and residual information to output compressed information. The compressed information includes compressed reference information and compressed residual information.

According to another aspect of the invention, the method receives pre-processing information that includes subimages associated with a scene. The method performs a first compression operation on the pre-processing information to generate reference information. The method performs a second compression operation on the reference information to output compressed reference information. The method performs a first decompression operation on the compressed reference information to output first decompressed reference information. The method performs a second decompression operation on the first decompressed reference information to generate first set of synthesized images.

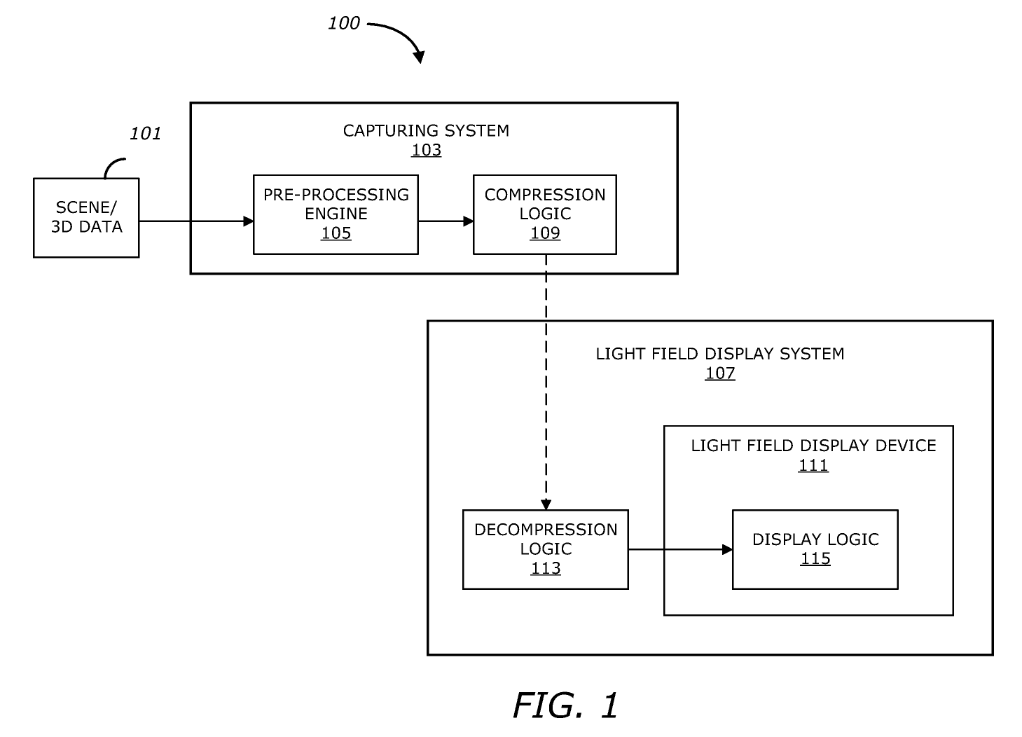

FIG. 1 illustrates a light field imaging system according to one embodiment of the invention. Referring to FIG. 1, light field imaging system 100 may include a capturing system 103 and a light field display system 107 that may be communicatively coupled to each other, for example, over a network (not shown), such as the Internet or cloud service. Capturing system 103 may include a capturing device (not shown) such as a light-field camera, action camera, animation camera, camcorder, camera phone, compact camera, digital camera, high-speed camera, mirrorless camera, or pinhole camera. In one embodiment, capturing system 103 includes, but is not limited to, pre-processing engine 105 (also referred to as pre-processing logic, pre-processing module, or pre-processing unit, which may be implemented in software, hardware, or a combination thereof) and compression logic 109 (also referred to as compression engine, compression module, or compression unit, which may be implemented in software, hardware, or a combination thereof).

Pre-processing engine 105 may capture, acquire, receive, create, format, store and/or provide light field input data (or scene/3D data) 101, which may represent an object or a scene, to be utilized at different stages of a compression operation (as discussed in more detail herein below). To do so, pre-processing engine 105 may generate a priori (or pre-processing) information associated with light field input data 101, for example object locations in the scene, bounding boxes, camera sensor information, target display information and/or motion vector information. Moreover, in some embodiments, pre-processing engine 105 may perform stereo matching and/or depth estimation on the light field input data 101 to obtain a representation of the spatial structure of a scene, for example one or more depth maps (or disparity maps) and/or subimages (or subaperture images) associated with the object or scene.

In one embodiment, pre-processing engine 105 may convert the light field input data 101 from data space to display space of light field display device 111. Conversion of the light field input data 101 from data space to display space may be needed for the light field display device 111 to show light field information in compliance with light field display characteristics and the user (viewer) preferences. When the light field input data 101 is based on camera input, for example, the light field capture space (or coordinates) and the camera space (or coordinates) are typically not the same, and as such, the pre-processing engine 105 may need to convert the data from any camera's (capture) data space to the display space. This is particularly the case when multiple cameras are used to capture the light field and only a portion of the captured light field in included in the viewer preference space. This data space to display space conversion is done by the pre-processing engine 105 by analyzing the characteristics of the light field display device 111 and, in some embodiments, the user (viewer) preferences. Characteristics of the light field display device 111 may include, but are not limited to, image processing capabilities, refresh rate, number of hogels and anglets, color gamut, and brightness. Viewer preferences may include, but are not limited to, object viewing preferences, interaction preferences, and display preferences.

In one embodiment, pre-processing engine 105 may take the display characteristics and the user preferences into account and convert the light field input data 101 from data space to display space. For example, if the light field input data 101 includes mesh objects, then pre-processing engine 105 may analyze the display characteristics (such as number of hogels, number of anglets, and FOV), analyze the user preferences (such as object placement and viewing preferences), calculate bounding boxes, motion vectors, etc., and report such information to the light field display system 107. In one embodiment, data space to display space conversion may include data format conversion and motion analysis in addition to coordinate transformation. In one embodiment, data space to display space conversion may involve taking into account the position of the light modulation surface (display surface) of the light field display device 111, and the object's position relative to the display surface.

Compression logic 109 may receive the a priori (or pre-processing) information from pre-processing engine 105 for compression. For example, compression logic 109 may execute one or more compression methods at different stages using the a priori information in order to generate compressed information (e.g., reference and/or residual information). In one embodiment, the compression methods may be based on image-based rendering (IBR), depth image-based rendering (DIBR), and/or multiple-reference depth image-based rendering (MR-DIBR). In one embodiment, the compression methods may, additionally or alternatively, be based on one or more image compression standards such as Joint Photographic Experts Group (JPEG), JPEG 2000, JPEG XS, or video compression standards (also referred to as video compression methods, video compression algorithms, or video compression codecs), such as Moving Picture Experts Group (MPEG), H.264, High Efficiency Video Coding (HEVC), Theora, RealVideo, RV40, VP9, AV1, Audio Video Interleaved (AVI), Flash Video (FLV), RealMedia, Ogg, QuickTime, and/or Matroska. Compression logic 109 may then communicate the compressed information, for example over a network (not shown), such as the Internet or cloud service, to decompression logic 113 to perform decompression operations. In one embodiment, the compressed information may be stored in a storage device (not shown) to be retrieved (or loaded) by decompression logic 113. The storage device, for example, may be a hard disk drive (HDD), solid state device (SSD), read only memory (ROM), random access memory (RAM), or optical storage media.

As further shown in FIG. 1, light field display system 107 may include, but is not limited to, decompression logic 113 (also referred to as decompression engine, decompression module, or decompression unit, which may be implemented in software, hardware, or a combination thereof) and light field display device 111 communicatively coupled to each other. The light field display device 111 may be any type of light field display device, such as a glasses-based 3D display device, autostereoscopic display device, VAC display device, or VAC-free full parallax 3D display device. As shown, light field display device 111 may include, but is not limited to, display logic 115 (also referred to as display engine, display module, or display unit, which may be implemented in software, hardware, or a combination thereof).

In one embodiment, decompression logic 113 may execute one or more decompression methods on the compressed information, which may be retrieved from the storage device, in order to generate decompressed information (e.g., reference and/or residual information). Additionally or alternatively, decompression logic 113 may further decompress some of the decompressed information (e.g., reference information) to produce synthesized images (e.g., elemental images or hogel images). Using the synthesized images and part of the decompressed information (e.g., residual information), decompression logic 113 may reconstruct the original object or scene represented by light field input data 101. The reconstructed images of the object or scene may be transmitted to display logic 115 to display, modulate or render on light field display device 111. As with the compression methods previously discussed, in one embodiment, the decompression operations may be based on IBR, DIBR, and/or MR-DIBR. In one embodiment, the decompression operations may, additionally or alternatively, be based on one or more image compression standards such as JPEG, JPEG 2000, JPEG XS, or one or more video compression standards, such as MPEG, H.264, HEVC, Theora, RealVideo, RV40, VP9, AV1, AVI, FLV, RealMedia, Ogg, QuickTime, and/or Matroska.

It should be appreciated that while FIG. 1 shows the light field capturing system 103 as being separate from the light field display system 107, in some embodiments the light field capturing system 103 may be part of the light field display system 107. It should also be appreciated that while FIG. 1 shows the pre-processing engine 105 as part of the light field capturing device 103, in some embodiments the pre-processing engine 105 may be part of the light field display system 107 or another system, logic, engine, module or unit. It should further be appreciated that while FIG. 1 shows the compression logic 109 as part of the capturing system 103, in some embodiments, compression logic 109 may be part of the light field display system 107 or another system, logic, engine, module or unit.

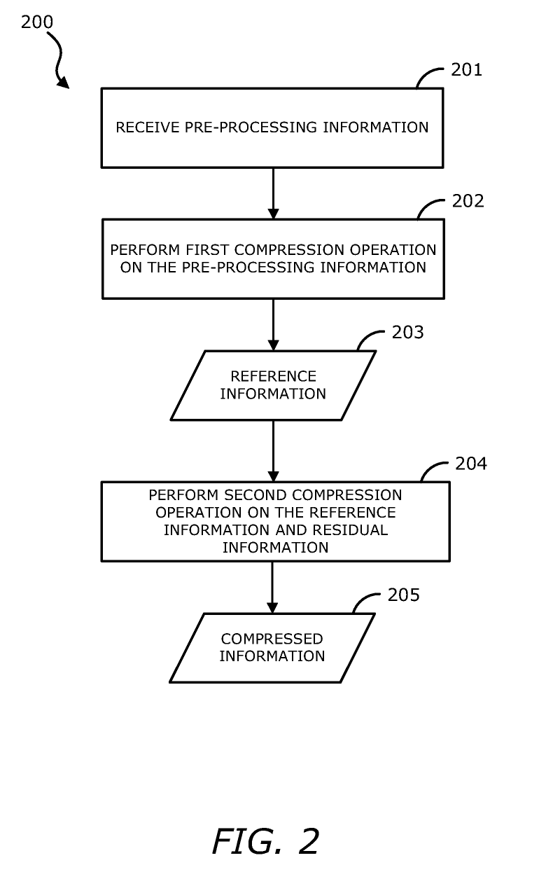

FIG. 2 is a flow diagram illustrating a method of light field compression according to one embodiment of the invention. Process 200 may be performed by processing logic that includes hardware (e.g. circuitry, dedicated logic, etc.), software (e.g., embodied on a non-transitory computer readable medium), or a combination thereof. For example, process 200 may be performed by compression logic 109 of FIG. 1.

Referring to FIG. 2, at block 201, the processing logic receives pre-processing information associated with light field input data 101. As previously described, pre-processing information may include object locations in the scene, bounding boxes, camera sensor information, target display information and/or motion vector information. In some embodiments, pre-processing information may include a representation of the spatial structure of a scene, for example one or more depth maps (or disparity maps) and/or subimages (or subaperture images) associated with the object or scene.

At block 202, the processing logic performs a first compression operation on the pre-processing information. For example, using depth maps and/or subimages (or subaperture images) from the pre-processing information, one or more light field compression methods (e.g., IBR, DIBR, or MR-DIBR) may be performed to generate reference information (as shown at block 203). The reference information, in one embodiment, may include reference images (e.g., elemental images or hogel images) and corresponding reference disparity maps.

Because there remain significant similarities among the reference elemental images in DIBR, for example, further compression is possible to improve bandwidth efficiencies. The same logic also applies to the disparity map operation. The elemental images and disparity maps from different spatial/angle locations can be rearranged in successive sequences and treated as temporal frames to be encoded by a video codec.

One of the biggest issues of any DIBR algorithm, however, is the generation of holes and cracks due to inaccuracy in depth values, round-off errors and object disocclusion. MR-DIBR reduces the holes significantly due to using multiple references; however, synthesized images can still be different from the original images. The differences between the original and estimated values of synthesized elemental images are defined as residual images, which can also be encoded by a video codec. By encoding the reference elemental images, disparity maps, and residual images with a video codec, the overall distortion can range from lossy to lossless with corresponding bit rate tradeoffs in fine-grained steps.

Accordingly, at block 204, the processing logic performs a second compression operation on the reference information and residual information, for example residuals of synthesized images, such as synthesized elemental or hogel images. As previously described, one or more image compression standards such as JPEG, JPEG 2000, JPEG XS, or one or more video compression standards, such as MPEG, H.264, HEVC, Theora, RealVideo, RV40, VP9, AV1, AVI, FLV, RealMedia, Ogg, QuickTime, and/or Matroska, may be executed to compress (or encode) the reference information and residual information, thereby outputting compressed information (as shown at block 205), which may include compressed reference and residual information.

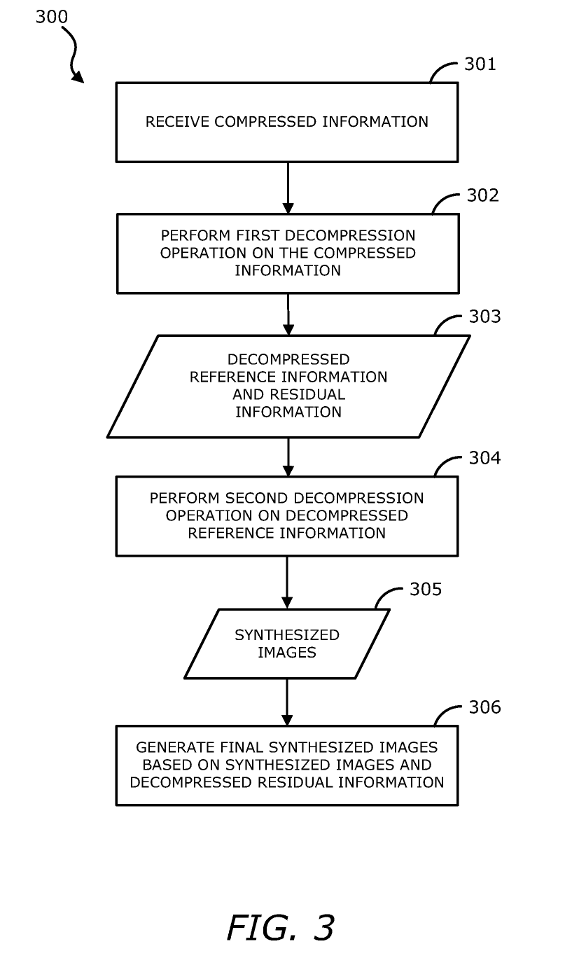

FIG. 3 is a flow diagram illustrating a method of light field decompression according to one embodiment of the invention. Process 300 may be performed by processing logic that includes hardware (e.g. circuitry, dedicated logic, etc.), software (e.g., embodied on a non-transitory computer readable medium), or a combination thereof. For example, process 300 may be performed by decompression logic 113 of FIG. 1.

Referring to FIG. 3, at block 301, the processing logic receives compressed information (e.g., compressed reference and residual information). At block 302, the processing logic performs a first decompression operation on the compressed information. For example, one or more image decompression standards such as JPEG, JPEG 2000, JPEG XS, or one or more video decompression (or decoding) standards, such as MPEG, H.264, HEVC, Theora, RealVideo, RV40, VP9, AV1, AVI, FLV, RealMedia, Ogg, QuickTime, and/or Matroska, may be executed to decompress (or decode) the compressed information and output decompressed reference information, for example reference images and reference disparity maps, and residual information, for example residuals of synthesized images (as shown at block 303). At block 304, the processing logic performs a second decompression operation on the decompressed reference information. In one embodiment, one or more light field decompression (or decoding) methods, such as IBR, DIBR or MR-DIBR, may be executed to produce or generate synthesized images (as shown at block 305). At block 306, the processing logic generates final synthesized (or rendered) images based on the synthesized images and decompressed residual information. As an example, in one embodiment the residual information may be added to the synthesized images to produce the final synthesized images, which may be modulated (or displayed) on a light field display device (e.g., light field display device 111 of FIG. 1).

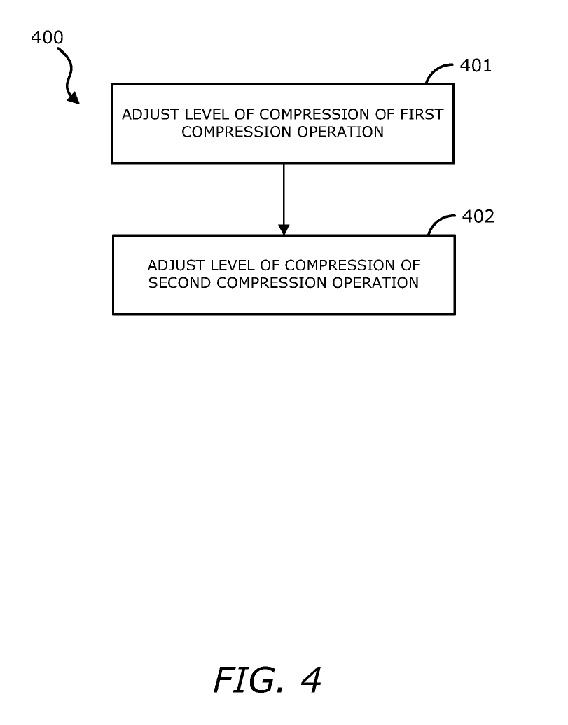

FIG. 4 is a flow diagram illustrating a method of adjusting levels of compression according to one embodiment of the invention. Process 400 may be performed by processing logic that includes hardware (e.g. circuitry, dedicated logic, etc.), software (e.g., embodied on a non-transitory computer readable medium), or a combination thereof. For example, process 400 may be performed by compression logic 109, decompression logic 113, or a combination thereof.

Referring to FIG. 4, at block 401, the processing logic adjusts a level of compression of a first compression operation, for example a light field compression method (as previously described). To adjust the level of compression, in one embodiment, certain adjustable parameters may be provided or fed as inputs to the light field compression method. For example, in one embodiment the adjustable parameters may include a bit rate given to the reference information (e.g., reference images and reference disparity maps), thereby controlling the compression level of the reference information. At block 402, the processing logic adjusts a level of compression of a second compression operation, for example a video compression method as previously described. In one embodiment, in order to adjust such level of compression, adjustable parameters may be provided or fed as inputs to the video compression method. For example, the adjustable parameters may include a bit rate given to the compressed information (e.g., compressed reference and residual information) so as to control the compression level of the compressed information.

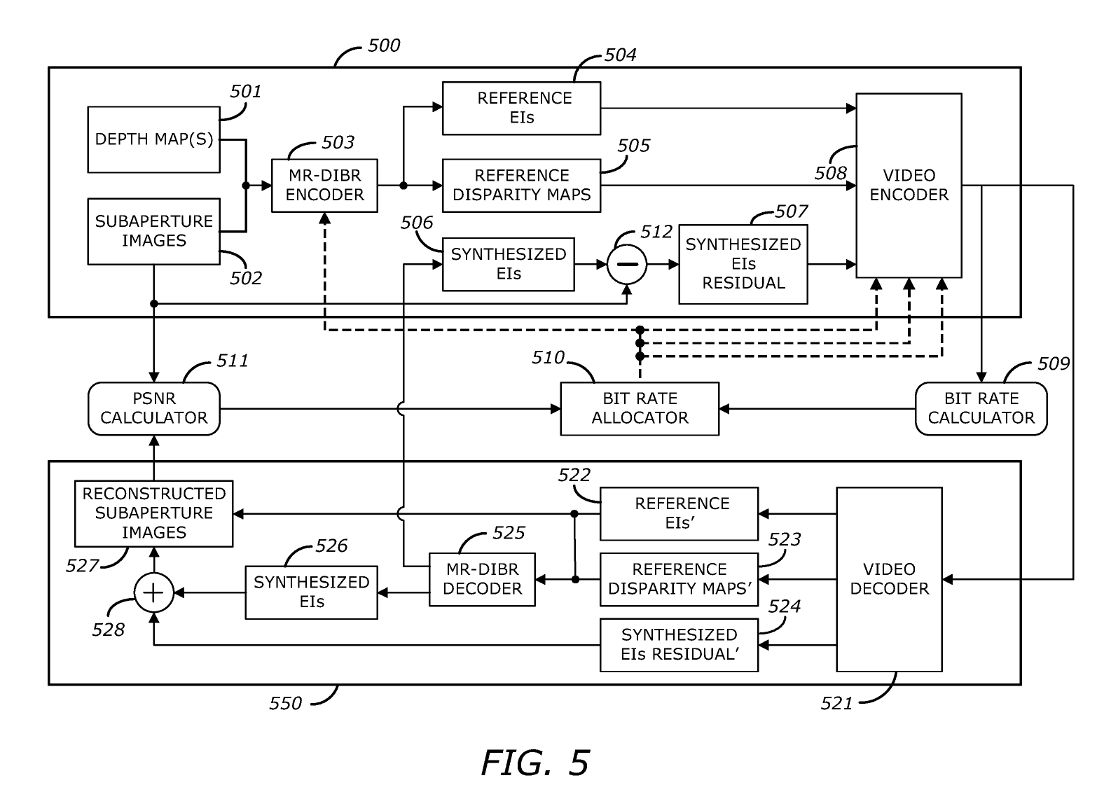

FIG. 5 is a block diagram illustrating an example of light field compression architecture according to one embodiment of the invention. In some embodiments, the light field compression architecture may be implemented as part of light field display system 107 of FIG. 1 (e.g., in compression logic 109 and/or decompression logic 113 of FIG. 1).

As shown in FIG. 5, the architecture includes an encoding stage 500 and a decoding stage 550. Encoding stage 500 includes MR-DIBR encoder 503 and video encoder 508. MR-DIBR encoder 503 may receive and compress one or more depth maps 501 and subaperture (or subimages) 502 at an adjustable bit rate in order to generate reference elemental images 504 (which may be referred to as “EIs”) and corresponding reference disparity maps 505. The reference EIs 504, reference disparity maps 505, and synthesized EIs residuals 507 (discussed in more detail herein below) may be provided to video encoder 508 (e.g., JPEG, JPEG 2000, or JPEG XS encoder, or MPEG, H.264, HEVC, Theora, RealVideo, RV40, VP9, AV1, AVI, FLV, RealMedia, Ogg, QuickTime, or Matroska encoder) for further compression. For example, video encoder 508 may compress (or encode) the reference EIs 504, reference disparity maps 505 and synthesized EIs residuals 507 at the adjustable bit rate in order to generate compressed information (e.g., compressed reference EIs, disparity maps, and synthesized EIs residuals). In one embodiment, video encoder 508 may include multiple HEVC encoders (e.g., three HEVC encoders) to encode the reference EIs 504, reference disparity maps 505 and synthesized EIs residuals 507.

As further shown in FIG. 5, the compressed information is communicated to bit rate calculator 509 to calculate an overall bit rate, and to video decoder 521 for decompression. For example, in one embodiment, output from each of the HEVC encoders may be added together to calculate the overall bit rate. The overall bit rate and peak signal-to-noise ratio (which may be referred to as “PSNR”) from PSNR calculator 511 may be provided to bit rate allocator 510 to allocate (or determine) a bit rate for MR-DIBR encoder 503 and video encoder 508. In one embodiment PSNR calculator 511 may compute the PSNR (e.g., the overall system distortion) by comparing decoded reference elemental images 522 and final synthesized images 527 (discussed in more detail herein below) to the original subaperture images 502. For example, PSNR calculator 511 may calculate the PSNR by taking a ratio between the original data from subaperture images 502 and the error (or noise) introduced by the compressions, which may be obtained from decoded reference elemental images 522 and/or final synthesized images 527. Performance of the overall system for example can be measured by the overall bit rate and distortion, which can be used to improve bit rate allocation among different components. Decoding stage 550 operates in reverse order and includes video decoder 521 and MR-DIBR decoder 525. As shown, video decoder 521 (e.g., JPEG, JPEG 2000, or JPEG XS decoder, or MPEG, H.264, HEVC, Theora, RealVideo, RV40, VP9, AV1, AVI, FLV, RealMedia, Ogg, QuickTime, or Matroska decoder) receives and decodes the compressed information from video encoder 508 to generate decoded reference elemental images 522 (also referred to as reference EIs'), decoded reference disparity maps 523 (also referred to as reference disparity maps'), and decoded synthesized EIs residuals 524 (also referred to as synthesized EIs residuals'). For example, video decoder 521 may include multiple video HEVC decoders (e.g., three HEVC decoders) to decode the compressed reference EIs, disparity maps, and synthesized EIs residuals generated by video encoder 508. The reference EIs' 522, reference disparity maps' 523 and synthesized EIs residuals' 524 are provided to MR-DIBR decoder 525 for further decompression. MR-DIBR decoder 525 decompresses reference EIs' 522, reference disparity maps' 523 and synthesized EIs residuals' 524 so as to generate synthesized EIs 506 and synthesized EIs 526 (which may be equivalent to each other or different from one another, in some embodiments). Synthesized EIs 506 may be subtracted, by subtractor 512, from subaperture images 502 to obtain synthesized EIs residuals 507. Synthesized EIs 526 may be added, by adder 528, to synthesized EIs residuals' 524 to obtain final synthesized images 527, which may be modulated (or displayed) on a light field display device (e.g., light field display device 111 of FIG. 1).

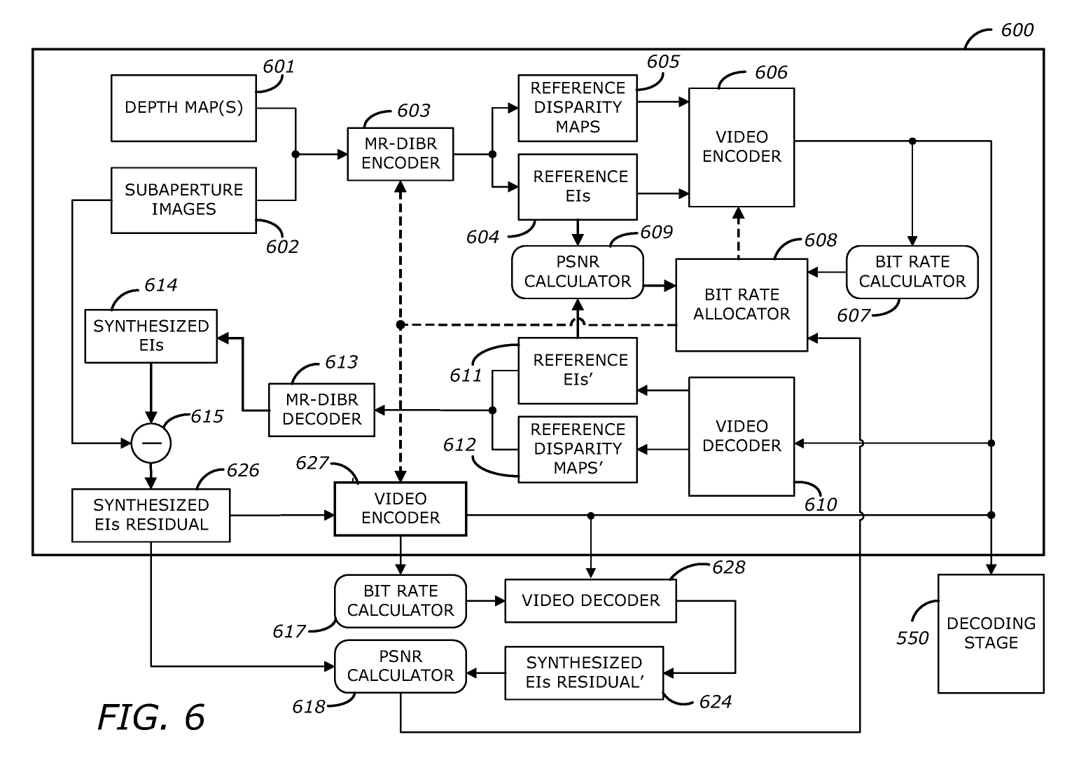

FIG. 6 is a block diagram illustrating another example of light field compression architecture according to one embodiment of the invention. In some embodiments, the light field compression architecture may be implemented as part of light field display system 107 of FIG. 1 (e.g., in compression logic 109 and/or decompression logic 113 of FIG. 1).

As shown in FIG. 6, the architecture includes encoding stage 600 and decoding stage 550 (which has been previously described, and for brevity sake, will not be described again). Encoding stage 600 may include MR-DIBR encoder 603, MR-DIBR decoder 613, video encoder 606, video encoder 627, and video decoder 610.

MR-DIBR encoder 603 may receive and compress one or more depth maps 601 and subaperture images 602 at an adjustable bit rate in order to generate reference EIs 604 and reference disparity maps 605. Reference EIs 604 and reference disparity maps 605 may be encoded by video encoder 606 (e.g., JPEG, JPEG 2000, or JPEG XS encoder, or MPEG, H.264, HEVC, Theora, RealVideo, RV40, VP9, AV1, AVI, FLV, RealMedia, Ogg, QuickTime, or Matroska encoder) at the adjustable bit rate to produce encoded (or compressed) information (which may include encoded reference EIs and encoded reference disparity maps). In one embodiment, video encoder 606 may include multiple HEVC encoders (e.g., two HEVC encoders) to encode the reference EIs 604 and reference disparity maps 605. The encoded information is communicated to bit rate calculator 607, video decoder 610, and decoding stage 550. Bit rate calculator 607 may serve to calculate an overall bit rate. For example, in one embodiment, output from each of the HEVC encoders may be added together to calculate the overall bit rate. The overall bit rate and PSNR from PSNR calculator 618 may be provided to bit rate allocator 608 to allocate (or determine) a bit rate for MR-DIBR encoder 603, video encoder 606, and video encoder 627.

Still referring to FIG. 6, video decoder 610 (e.g., JPEG, JPEG 2000, or JPEG XS decoder, or MPEG, H.264, HEVC, Theora, RealVideo, RV40, VP9, AV1, AVI, FLV, RealMedia, Ogg, QuickTime, or Matroska decoder) may receive and decode the encoded information from video encoder 606 at a varying (or adjustable) bit rate to produce reference EIs' 611 and reference disparity maps' 612. Reference EIs' 611 and reference EIs 604 (as previously described) may be sent to PSNR calculator 609 for PSNR calculation. For example, in one embodiment PSNR calculator 609 may calculate the PSNR by comparing reference EIs' 611 to reference EIs 604. Reference EIs' 611 and reference disparity maps' 612 may further be decompressed by MR-DIBR decoder 613 to generate synthesized EIs 614. Synthesized EIs 614 may be subtracted, by subtractor 615, from the original subaperture images 602 to produce synthesized EIs residuals 626, which may be provided to video encoder 627 (e.g., HEVC encoder) for encoding at the adjustable bit rate. The encoded synthesized EIs residuals may be provided to bit rate calculator 617, and also to video decoder 628 and decoding stage 550 for decompression. Bit rate calculator 617 may provide an effective bit rate to video decoder 628 based on the encoded synthesized EIs residuals to produce synthesized EIs residuals' 624. Decoding stage 550 (as previously described) may generate final synthesized images that may be modulated (or displayed) on a light field display device (e.g., light field display device 111 of FIG. 1). As further shown in FIG. 6, synthesized EIs residuals' 624 and synthesized EIs residuals 626 may be transmitted to PSNR calculator 618. For example, in one embodiment PSNR calculator 618 may calculate the PSNR by comparing synthesized EIs residuals' 624 to synthesized EIs residuals 626.

Using the disclosed encoding scheme, an important system parameter is the rate distribution among the various encoding blocks, for example the MR-DIBR encoder 503 and video encoder 508. In one embodiment, adjustable parameters in MR-DIBR encoder 503 and MR-DIBR encoder 603 may include the number of reference EIs and corresponding disparity maps. In one embodiment, adjustable parameters in the video encoders 508, 606 and 627 are those intrinsic to an image encoding algorithm (e.g., JPEG, JPEG 2000, or JPEG XS) or video encoding algorithm (e.g., MPEG, H.264, HEVC, Theora, RealVideo, RV40, VP9, AV1, AVI, FLV, RealMedia, Ogg, QuickTime, or Matroska). In one embodiment, adjustable parameters in video encoder 508 of synthesized EIs residuals include those of the HEVC intrinsic parameters as well as the decision of whether to encode or ignore the residual errors. In theory, it may be desired to allocate relatively more rate budget on encoding the MR-DIBR reference elemental images and corresponding disparity maps (e.g., MR-DIBR encoders 503 and 603. This is due to the propagation nature of errors in the reference images and disparity map to the synthesized images. In practice, the optimal allocation varies by (types of) light field images. Moreover, different implementations of the proposed combined MR-DIBR and video (e.g., HEVC) encoding may exist and provide tradeoffs of complexity versus performance (in terms of rate-distortion) based on user-defined selections of performance metrics.

It should be appreciated that while the foregoing discussion may imply that the number of residuals are equal to the total number of images needed to be synthesized from the reference images and disparity maps, such however is not necessarily the case. In some embodiments, the number of residuals can be smaller than the number of images that need to be synthesized. For example, if there is a quality threshold that requires all synthesized images to be above 30 dB, only the images that fall below the threshold may get residuals to improve their quality to above 30 dB, while the synthesized images that have a PSNR value of greater than 30 dB do not get any residuals. The number of residuals can also be determined by other factors, for example, raising the quality of a certain number of the lowest quality synthesized images, such as 10 or 10% of the number of synthesized images, etc.

In another embodiment, the residuals are used in a manner similar to the reference images and reference disparity maps. Once the images that have reference residuals are synthesized, they may become reference images for the unsynthesized images (e.g., hogels, subimages, subaperture images, or elemental images) placed in close proximity to them.

In some embodiments, one way to select these reference residuals is to place them between the original reference images (e.g., hogels, elemental images). This is because the synthesis error may become larger as the synthesized images (e.g., hogels, elemental images) move farther from the reference images. By placing a reference residual between all reference images, the total synthesis error in the process may be reduced, for example, by about 50%. If two reference residuals are placed between any two reference images, the synthesis error may be reduced, for example, by 66%.

In some embodiments, different methods can be used to determine the number of reference residuals required in the encoding operation. A first method is to add as many residuals as necessary to reduce the synthesis error in the scene to less than 0.5 pixels. A synthesis error of less than 0.5 pixels can be considered lossless. This is achieved by the following formula:

#residual references=[(maximum synthesis error in unit of pixels)/0.5]−1

If the image distance between the two reference images is smaller than the number found by the above formula, then all the possible residuals should be used.

A second method to determine the number of reference residuals uses the bit rate requirement. If the bit rate demands significant compression, the number of reference residuals can be kept relatively low, and if the bit rate demands a small amount of compression then the number of reference residuals may be increased.

In another embodiment, residuals for the synthesized images may include a disparity map component in addition to the image component. The disparity component of the residual is calculated by subtracting the warped disparity from original disparity data.

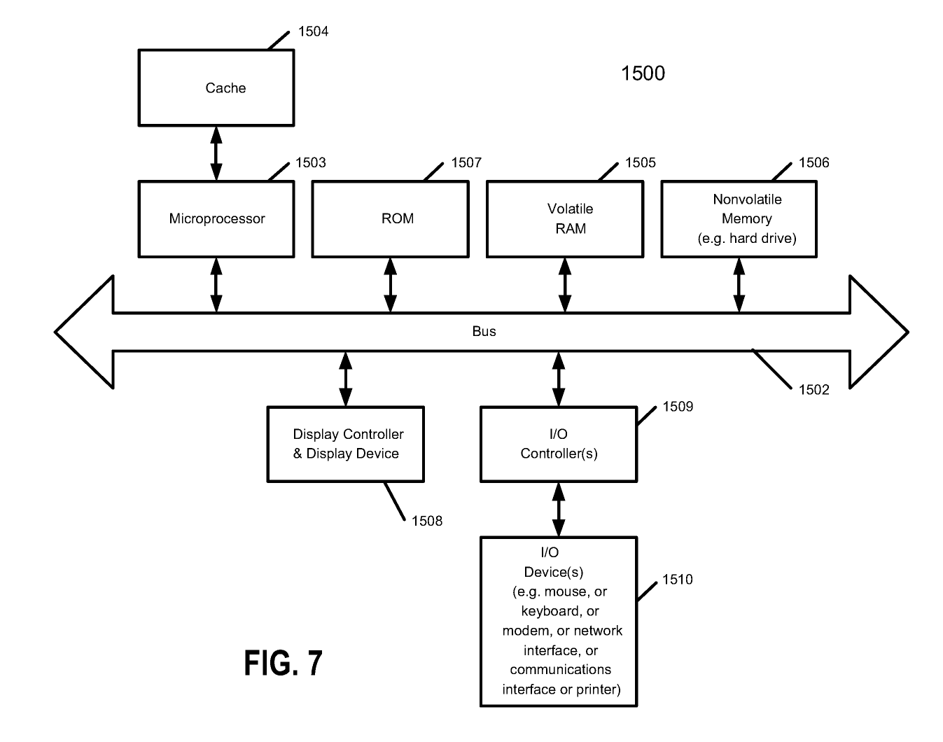

FIG. 7 is a block diagram of a data processing system, which may be used with one embodiment of the invention. For example, the system 1500 may be used as part of capturing system 103, light field display system 107 and/or light field display device 111 as shown in FIG. 1. Note that while FIG. 7 illustrates various components of a computer system, it is not intended to represent any particular architecture or manner of interconnecting the components, as such details are not germane to the invention. It will also be appreciated that network computers, handheld computers, mobile devices (e.g., smartphones, tablets) and other data processing systems which have fewer components or perhaps more components may also be used with the invention.

As shown in FIG. 7, the system 1500, which is a form of a data processing system, includes a bus or interconnect 1502 which is coupled to one or more microprocessors 1503 and a ROM 1507, a volatile RAM 1505, and a non-volatile memory 1506. The microprocessor 1503 is coupled to cache memory 1504. The bus 1502 interconnects these various components together and also interconnects these components 1503, 1507, 1505, and 1506 to a display controller and display device 1508, as well as to input/output (I/O) devices 1510, which may be mice, keyboards, modems, network interfaces, printers, and other devices which are well-known in the art.

Typically, the input/output devices 1510 are coupled to the system through input/output controllers 1509. The volatile RAM 1505 is typically implemented as dynamic RAM (DRAM) which requires power continuously in order to refresh or maintain the data in the memory. The non-volatile memory 1506 is typically a magnetic hard drive, a magnetic optical drive, an optical drive, or a DVD RAM or other type of memory system which maintains data even after power is removed from the system. Typically, the non-volatile memory will also be a random access memory, although this is not required.

While FIG. 7 shows that the non-volatile memory is a local device coupled directly to the rest of the components in the data processing system, a non-volatile memory that is remote from the system may be utilized, such as, a network storage device which is coupled to the data processing system through a network interface such as a modem or Ethernet interface. The bus 1502 may include one or more buses connected to each other through various bridges, controllers, and/or adapters, as is well-known in the art. In one embodiment, the I/O controller 1509 includes a Universal Serial Bus (USB) adapter for controlling USB peripherals. Alternatively, I/O controller 1509 may include an IEEE-1394 adapter, also known as FireWire adapter, for controlling FireWire devices.

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method of light field image compression, the method being implemented by one or more processors, the method comprising:
receiving pre-processing information including subimages associated with a scene;
performing a first compression operation on the pre-processing information to generate reference information; and
performing a second compression operation on the reference information and residual information to output compressed information;
wherein the compressed information includes compressed reference information and compressed residual information.

2. The method of claim 1, further comprising:
receiving the compressed information;
performing a first decompression operation on the compressed information to output decompressed reference information and decompressed residual information;
performing a second decompression operation on the decompressed reference information to generate synthesized images; and
generating final synthesized images based on the synthesized images and the decompressed residual information;
wherein the residual information is calculated based on the subimages and the synthesized images.

3. The method of claim 2, further comprising:
adjusting a first compression level of the first compression operation; and
adjusting a second compression level of the second compression operation.

4. The method of claim 1, wherein the pre-processing information further includes one or more depth maps associated with the scene.

5. The method of claim 1, wherein
the first compression operation is based on one of the following light field compression methods: image-based rendering (IBR), depth image-based rendering (DIBR), or multiple-reference depth image-based rendering (MR-DIBR),
the second compression operation is based on one of the following image compression standards: Joint Photographic Experts Group (JPEG), JPEG 2000, or JPEG XS, or one of the following video compression standards: Moving Picture Experts Group (MPEG), H.264, High Efficiency Video Coding (HEVC), Theora, RealVideo, RV40, VP9, AV1, Audio Video Interleaved (AVI), Flash Video (FLV), RealMedia, Ogg, QuickTime, or Matroska.

6. The method of claim 2, wherein
the reference information includes reference images and reference disparity maps, and
the residual information includes residuals of the synthesized images.

7. The method of claim 6, wherein the residuals of the synthesized images are calculated by subtracting the synthesized images from the subimages.

8. The method of claim 2, wherein
the first decompression operation is based on one of the following light field decompression methods: image-based rendering (IBR), depth image-based rendering (DIBR), or multiple-reference depth image-based rendering (MR-DIBR),
the second decompression operation is based on one of the following image decompression standards: Joint Photographic Experts Group (JPEG), JPEG 2000, or JPEG XS, or one of the following video decompression standards: Moving Picture Experts Group (MPEG), H.264, High Efficiency Video Coding (HEVC), Theora, RealVideo, RV40, VP9, AV1, Audio Video Interleaved (AVI), Flash Video (FLV), RealMedia, Ogg, QuickTime, or Matroska.

9. The method of claim 2, wherein
the decompressed reference information includes decompressed reference images and decompressed reference disparity maps, and
the decompressed residual information includes decompressed residuals of the synthesized images.

10. The method of claim 9, wherein generating final synthesized images comprises adding the decompressed residuals of the synthesized images to the synthesized images.

11. The method of claim 3, wherein
adjusting the first compression level of the first compression operation comprises providing an adjustable bit rate to the first compression operation to control the compression level of the reference information,
adjusting the second compression level of the second compression operation comprises providing the adjustable bit rate to the second compression operation to control the compression level of the compressed information.

12. The method of claim 11, wherein the adjustable bit rate is allocated based on an overall bit rate and a peak signal-to-noise ratio.

13. A computer-implemented method of light field image compression, the method being implemented by one or more processors, the method comprising:
receiving pre-processing information including subimages associated with a scene;
performing a first compression operation on the pre-processing information to generate reference information;
performing a second compression operation on the reference information to output compressed reference information;
performing a first decompression operation on the compressed reference information to output first decompressed reference information; and
performing a second decompression operation on the first decompressed reference information to generate first set of synthesized images.

14. The method of claim 13, further comprising:
calculating and producing residuals of the first set of synthesized images based on the subimages and the first set of synthesized images;
performing a third compression operation on the residuals of the first set of synthesized images to output compressed residual information;
performing a third decompression operation on the compressed residual information to output first decompressed residual information.

15. The method of claim 14, further comprising:
performing a fourth decompression operation on the compressed reference information and the compressed residual information to output second decompressed reference information and second decompressed residual information;
performing a fifth decompression operation on the second decompressed reference information to generate second set of synthesized images; and
generating final synthesized images based on the second set of synthesized images and the second decompressed residual information.

16. The method of claim 15, further comprising:
adjusting a first compression level of the first compression operation;
adjusting a second compression level of the second compression operation; and
adjusting a third compression level of the third compression operation.

17. The method of claim 13, wherein the pre-processing information further includes one or more depth maps associated with the scene.

18. The method of claim 15, wherein
the first compression operation is based on one of the following light field compression methods: image-based rendering (IBR), depth image-based rendering (DIBR), or multiple-reference depth image-based rendering (MR-DIBR),
each of the second and third compression operations is based on one of the following image compression standards: Joint Photographic Experts Group (JPEG), JPEG 2000, or JPEG XS, or one of the following video compression standards: Moving Picture Experts Group (MPEG), H.264, High Efficiency Video Coding (HEVC), Theora, RealVideo, RV40, VP9, AV1, Audio Video Interleaved (AVI), Flash Video (FLV), RealMedia, Ogg, QuickTime, or Matroska,
each of the first, third and fourth decompression operations is based on one of the following image decompression standards: JPEG, JPEG 2000, or JPEG XS, or one of the following video decompression standards: MPEG, H.264, HEVC, Theora, RealVideo, RV40, VP9, AV1, AVI, FLV, RealMedia, Ogg, QuickTime, or Matroska,
each of the second and fifth decompression operations is based on one of the following light field decompression methods: IBR, DIBR, or MR-DIBR.

19. The method of claim 13, wherein
the reference information includes reference images and reference disparity maps,
the compressed reference information includes compressed reference images and compressed reference disparity maps,
the first decompressed reference information includes first decompressed reference images and first decompressed reference disparity maps.

20. The method of claim 14, wherein
the compressed residual information includes compressed residuals of the first set of synthesized images,
the first decompressed residual information first decompressed residuals of the first set of synthesized images.

21. The method of claim 15, wherein
the second decompressed reference information includes second decompressed reference images and second decompressed reference disparity maps,
the second decompressed residual information includes second decompressed residuals of the second set of synthesized images.

22. The method of claim 16, wherein
adjusting the first compression level of the first compression operation comprises providing an adjustable bit rate to the first compression operation to control the compression level of the reference information,
adjusting the second compression level of the second compression operation comprises providing the adjustable bit rate to the second compression operation to control the compression level of the compressed reference information,
adjusting the third compression level of the third compression operation comprises providing the adjustable bit rate to the third compression operation to control the compression level of the compressed residual information.

23. The method of claim 14, wherein the residuals of the first set of synthesized images are calculated by subtracting the first set of synthesized images from the subimages.

24. The method of claim 15, wherein generating final synthesized images comprises adding the second decompressed residual information to the second set of synthesized images.
